(19) United States
(12) Patent Application Publication
(10) Pub. No.: US 2005/0104953 A1
(43) Pub. Date: May 19, 2005

(54) Image exposure method and image exposure apparatus

(75) Inventors: Issei Suzuki, Kanagawa (JP); Hiroshi Sunagawa, Kanagawa (JP); Tsukasa Ono, Kanagawa (JP); Takayuki Uemura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 10/938,885

(22) Filed: Sep. 13, 2004

(30) Foreign Application Priority Data
Sep. 16, 2003 (JP) 2003-323060
Sep. 16, 2003 (JP) 2003-323065

(51) Int. Cl. B41J 2/45

(52) U.S. Cl. 347/238

(57) ABSTRACT

In an image exposure apparatus, a scanning movement of an exposure head exposes a sensitive member of a recording medium. The image exposure apparatus comprises: an optical fiber holding member that movably holds a part of the optical fiber up to the exposure head; a photo detector that detects light quantity of emitted light from the exposure head during a movement of the optical fiber by the optical fiber holding member; a control means that drives the semiconductor laser in a state that the exposure head is fixed, while the optical fiber holding member is moved; and an operating means that operates average light quantity in accordance with the light quantity detected by the photo detector, and operates a value of current to drive the semiconductor laser in accordance with a difference between the average light quantity and a target light quantity necessary for exposure.

### BACKGROUND OF THE INVENTION

1. Field of the Invention

The present invention relates to an image exposure method and an image exposure apparatus, in which a light beam emitted from a semiconductor laser is introduced through an optical fiber to an exposure head, so that a recording medium wound around a drum is exposed.

2. Description of the Related Art

Hitherto, as a technology of an image exposure apparatus for scan-exposing a recording medium by light beam emitted from a semiconductor laser, there is known such a technology that optical fibers from a plurality of semiconductor lasers are coupled to an exposure head, and in the exposure head laser beam emission outlets of the optical fibers are arranged in form of a fiber array, so that scanning exposures by the laser beams emitted from the semiconductor lasers are simultaneously performed. According to such an image exposure apparatus, while the plurality of semiconductor lasers is driven in accordance with image data representative of an image to be recorded, the exposure head is moved, and a plurality of lines on a recording medium is simultaneously scanned with light emitted from the exposure head so that an image is exposed. This feature makes it possible to contribute to reducing the exposure time.

FIG. 14 is a schematic view of an image exposure apparatus of a so-called outer drum optical fiber array exposure system.

The image forming apparatus comprises: a plurality of semiconductor lasers 21 for emitting light for multi-channel exposure; a plurality of optical fibers 70 for introducing light from the semiconductor lasers 21; an exposure head 30 comprising an optical system 38 consisting of a fiber array 31, a collimator lens 32, an aperture 33, and an imaging lens 34; and a rotating drum 50 around which a recording medium F such as a recording film is wound. The plurality of optical fibers 70 is arranged in the fiber array 31.

When the plurality of semiconductor lasers 21 is driven by a driving circuit (not illustrated) for outputting a driving current in accordance with image data for recording, the plurality of semiconductor lasers 21 emits light. The emitted light is introduced via the plurality of optical fibers 70 to the fiber array 31 so that light of light quantity according to the emitted light from the semiconductor lasers 21 is emitted from the optical fibers 70 via the collimator lens 32, the aperture 33, and the imaging lens 34 to the recording medium F. When the rotating drum 50 rotates in a peripheral direction, the recording medium F is subjected to the main scanning, and while the exposure head 30 is moved in a parallel direction with a rotary shaft of the rotating drum 50, the recording medium F is subjected to the sub-scanning.

In such an image exposure apparatus, variation in light quantity of lights emitted from the semiconductor lasers at the time of exposure would bring about unevenness in density on the exposed image. In order to suppress the unevenness in density, there is a need to make even light quantity of lights emitted from the semiconductor lasers at the time of exposure so as to be the same light quantity. For this reason, there is performed a light quantity monitor in the manner as set forth below.

At the position out of an area of an image recording by the exposure head 30, there is disposed a monitoring photo detector 12 for detecting light quantity of laser beams of the semiconductor lasers 21 emitted from the exposure head 30. Whenever the exposure to the recording medium F is carried out, the exposure head 30 is positioned at the photo detector 12 beforehand to detect light quantity of laser beams emitted from the semiconductor lasers 21, and operation and control circuit (not illustrated) provides such a control that light quantity emitted from the semiconductor lasers 21 becomes a predetermined value, in accordance with the detected light quantity by the photo detector 12.

As another prior art, there is proposed a laser printer using a plurality of semiconductor lasers as a light source, in which a photo detector for a light quantity monitor is disposed at a position apart from a recording medium to monitor the light quantity of light from the semiconductor lasers prior to an image exposure, and the emission of the semiconductor lasers is controlled in such a manner that the light quantity approaches a predetermined set value (for example, Japanese Patent Application Laid Open Gazette TokuKai. Sho. 56-140477 (Pages 1-5, FIG. 1 and FIG. 6).

In the image exposure apparatus shown in FIG. 14, the optical fibers 70 are bundled up and are accommodated in a cable bear 43 (registered trademark) which is flexible holding member. At the time of the sub-scanning, the optical fibers 70 moves bending in the wake of the exposure head 30. A waveguide mode (a light intensity distribution in the optical fiber) varies in accordance with a bending state of the optical fibers 70, so that a far-field pattern of the emitted light from the optical fiber varies. On the other hand, a size of the aperture of the optical system 38 of the exposure head 30 is finite. And thus when the far-field pattern is expanded, the emitted light from the optical fibers 70 will be rejected by a cover portion around the aperture. Accordingly, bending of the optical fibers 70 causes the far-field pattern of the emitted light from the optical fiber to vary, so that the light quantity passing through the optical system 38 of the exposure head 30 varies. Thus, the light quantity of the recording medium F on the exposure surface will vary as follows.

FIG. 15 is a view useful for understanding a variation of light quantity in exposure in the conventional image exposure apparatus.

As will be seen from part (a) of FIG. 15, the photo detector 12 performs the light quantity monitor at the time during the stop of the sub-scanning. Accordingly, if there occurs light quantity variation of the maximum ±5%, for instance, during the sub-scanning, it happens that channel Ch1 may monitor the light quantity lower 5% than the average light quantity during the sub-scanning, and channel Ch2 may monitor the light quantity higher 5% than the average light quantity during the sub-scanning. If the light quantities of the channels Ch1 and Ch2 are set up in accordance with the monitor values, as will be seen from part (b) of FIG. 15, as compared with the set up light quantity as the target, the channel Ch1 is larger 5% in the average light quantity, and the channel Ch2 is smaller 5% in the average light quantity. In other words, the variation in light quantity between the channels is the maximum ±5%. This appears as unevenness in exposure.

Thus, in order that the semiconductor lasers 21 emit light of substantially same light quantity on the exposure surface (photosensitive material surface), it is intended that the photo detector 12 monitors light quantity, so that light quantity on the exposure surface is even. However, there exists variation in light quantity between the channels. Accordingly, when the light quantity of the semiconductor lasers 21 is controlled in accordance with the monitored light quantity to perform the exposure, the light quantity on the exposure surface of the recording medium varies, and as a result there occurs variation in exposure.

According to the laser printer disclosed in the above-referenced Japanese Patent Application Laid Open Gazette TokuKai. Sho. 56-140477, light emitted from the semiconductor lasers is transmitted to a rotary polyhedron, so that the reflected laser beam causes an exposure spot to form an image on a photosensitive drum to perform an image recording. This laser printer uses no optical fibers for leading the laser beam to the drum, and thus with respect to the problems as mentioned above, there is no problem. However, according to such a laser printer, it is impossible to reduce the exposure time by means of exposure of an image through simultaneous scanning of a plurality of lines.

### SUMMARY OF THE INVENTION

In view of the foregoing, it is an object of the present invention to provide an image exposure apparatus capable of controlling light quantity with greater accuracy by monitoring in the state near the actual sub-scanning.

To achieve the above-mentioned object, the present invention provides an image exposure method in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure method comprising:
a first step of deforming the optical fiber while the semiconductor laser is driven;
a second step of detecting light quantity of emitted light from the exposure head during an operation of deformation of the optical fiber;
a third step of operating average light quantity in accordance with the light quantity detected in the second step;
a fourth step of operating a value of current to drive the semiconductor laser in accordance with a difference between the average light quantity and a target light quantity necessary for exposure; and
a fifth step of driving the semiconductor laser with the current of the value operated in the fourth step to expose the recording medium.

According to the image exposure method of the present invention, since the photo detection is carried out when the optical fiber performs the bending and behavior which are approximated to a case where the exposure head actually performs exposure, it is possible to accurately compute the target light quantity necessary for the exposure, and also to reduce variation in light quantity at the time of the exposure and thereby performing the exposure with greater accuracy.

In the image exposure method according to the present invention as mentioned above, it is preferable that the first step is a step in which while the optical fiber is deformed, pluralities of semiconductor lasers are driven with pulses on a time sequence basis.

This feature makes it possible to monitor a plurality of channels at once, and thereby improving productivity as compared with a method of monitoring channels one by one.

To achieve the above-mentioned object, the present invention provides a first image exposure apparatus in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure apparatus comprising:
an optical fiber holding member that movably holds a part of the optical fiber up to the exposure head;
a photo detector that detects light quantity of emitted light from the exposure head during a movement of the optical fiber by the optical fiber holding member;
a control means that drives the semiconductor laser in a state that the exposure head is fixed, while the optical fiber holding member is moved; and
an operating means that operates average light quantity in accordance with the light quantity detected by the photo detector, and operates a value of current to drive the semiconductor laser in accordance with a difference between the average light quantity and a target light quantity necessary for exposure.

According to the first image exposure apparatus as mentioned above, it is possible to reduce variation in light quantity at the time of the exposure, and also to utilize the image exposure apparatus without alteration of the exposure head as shown in FIG. 14 and thereby implementing the image exposure apparatus with low cost.

In the first image exposure apparatus according to the present invention as mentioned above, it is preferable that the semiconductor laser is of a plurality, and the control means drives the plurality of semiconductor lasers with pulses on a time sequence basis in the state that the exposure head is fixed, while the optical fiber holding member is moved.

This feature makes it possible to monitor a plurality of channels at once, and thereby improving productivity as compared with a method of monitoring channels one by one.

In the first image exposure apparatus according to the present invention as mentioned above, it is acceptable that the image exposure apparatus further comprises a rotating drum around which the recording medium is wound for image recording, wherein the exposure head moves in parallel to a rotary shaft of the rotating drum to perform a sub-scanning, and the exposure head perform a main scanning by a movement of the recording medium by a rotation of the rotating drum. This scheme is referred to as an outer drum exposure system.

In the first image exposure apparatus according to the present invention as mentioned above, it is acceptable that the image exposure apparatus further comprises a drum, and a pair of capstans, which cause the recording medium to move in a peripheral direction of the drum when the drum rotates urging the recording medium to the drum, and wherein the exposure head performs a main scanning by a movement of the exposure head in a direction perpendicular to a movement direction of the recording medium, and the exposure head performs a sub-scanning by a movement of the recording medium by the capstans. This scheme is referred to as a drum capstan exposure system.

In the first image exposure apparatus according to the present invention as mentioned above, it is preferable that the image exposure apparatus further comprises a flexible protecting member provided around the optical fiber.

In the first image exposure apparatus according to the present invention as mentioned above, it is preferable that the operating means supplies a driving current of either one of driving currents I1 and I2, which cause the semiconductor laser to emit lights of light quantities P1 and P2 before and after a target light quantity P, to the semiconductor laser in a forward way of reciprocation as a movement of an optical fiber moving means in one direction, and the operating means supplies another driving current of the driving currents I1 and I2 to the semiconductor laser in a returning way of reciprocation as a movement of the optical fiber moving means in another direction, so that the operating means determines a driving current I in accordance with a formula set forth below.
I=I1+(P−P1)(I2−I1)/(P2−P1)

This feature may avoid a necessity for operation to return the optical fiber moving means to the home position and thereby saving a measuring time.

To achieve the above-mentioned object, the present invention provides a second image exposure apparatus in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure apparatus comprising:
a photo detector that detects light quantity of emitted light from the exposure head during a movement of the exposure head;
a control means that drives the semiconductor laser, while the exposure head is moved; and
an operating means that operates average light quantity in accordance with the light quantity detected by the photo detector, and operates a value of current to drive the semiconductor laser in accordance with a difference between the average light quantity and a target light quantity necessary for exposure.

According to the second image exposure apparatus as mentioned above, since the photo detection is carried out when the optical fiber performs the bending and behavior which are equivalent to a case where the exposure head actually performs exposure, it is possible to accurately compute the target light quantity necessary for the exposure, and also to reduce variation in light quantity at the time of the exposure and thereby performing the exposure with greater accuracy.

In the second image exposure apparatus according to the present invention as mentioned above, it is preferable that the semiconductor laser is of a plurality, and the control means drives the plurality of semiconductor lasers with pulses on a time sequence basis, while the exposure head is moved.

This feature makes it possible to monitor a plurality of channels at once, and thereby improving productivity as compared with a method of monitoring channels one by one.

In the second image exposure apparatus according to the present invention as mentioned above, it is acceptable that the image exposure apparatus further comprises a rotating drum around which the recording medium is wound for image recording, wherein the exposure head moves in parallel to a rotary shaft of the rotating drum to perform a sub-scanning, and the exposure head perform a main scanning by a movement of the recording medium by a rotation of the rotating drum. This scheme is referred to as an outer drum exposure system.

In the second image exposure apparatus according to the present invention as mentioned above, it is acceptable that the image exposure apparatus further comprises a drum, and a pair of capstans, which cause the recording medium to move in a peripheral direction of the drum when the drum rotates urging the recording medium to the drum, and
wherein the exposure head performs a main scanning by a movement of the exposure head in a direction perpendicular to a movement direction of the recording medium, and the exposure head performs a sub-scanning by a movement of the recording medium by the capstans. This scheme is referred to as a drum capstan exposure system.

In the second image exposure apparatus according to the present invention as mentioned above, it is preferable that the exposure head has a half mirror included in an optical system of the exposure head, the half mirror directing light emitted from the optical fiber to a direction of the recording medium and reflecting the light emitted from the optical fiber to a direction of the photo detector.

In the second image exposure apparatus according to the present invention as mentioned above, it is preferable that the exposure head has a total reflection mirror removably included in an optical system of the exposure head, the total reflection mirror reflecting light emitted from the optical fiber to a direction of the photo detector.

In the second image exposure apparatus according to the present invention as mentioned above, it is preferable that the photo detector is mounted on the exposure head via a photo detector moving mechanism that moves to a position to receive emitted light of the exposure head and moves to a position saving from the position to receive emitted light of the exposure head.

In the second image exposure apparatus according to the present invention as mentioned above, it is preferable that the operating means supplies a driving current of either one of driving currents I1 and I2, which cause the semiconductor laser to emit lights of light quantities P1 and P2 before and after a target light quantity P, to the semiconductor laser in a forward way of reciprocation as a movement of an optical fiber moving means in one direction, and the operating means supplies another driving current of the driving currents I1 and I2 to the semiconductor laser in a returning way of reciprocation as a movement of the optical fiber moving means in another direction, so that the operating means determines a driving current I in accordance with a formula set forth below.
I=I1+(P−P1)(I2−I1)/(P2−P1)

This feature may avoid a necessity for operation to return the exposure head to the home position and thereby saving a measuring time.

### BRIEF DESCRIPTION OF THE DRAWINGS

FIG. 1 is a perspective view of an image exposure apparatus according to a first embodiment of the present invention.

FIG. 2 is a side elevation of an optical fiber moving mechanism (1) of the first embodiment of the present invention;

FIG. 3 is a side elevation of an optical fiber moving mechanism (2) of the first embodiment of the present invention.

FIG. 4 is a circuit diagram of a control system of an image exposure apparatus of the present invention.

FIG. 5 is a view of timings of light emission pulses of channels at the time of monitor.

FIG. 6 is a view of monitored light quantity values of channels at the time of monitor.

FIG. 7 is an explanatory view useful for understanding a light quantity control by an interpolation.

FIG. 8 is a flowchart useful for understanding processing when the image recording is performed.

FIG. 9 is a perspective view of an image exposure apparatus according to a second embodiment of the present invention.

FIG. 10 is a plan view of an exposure head portion of the second embodiment.

FIG. 11 is a plan view of an exposure head portion of an image exposure apparatus according to a third embodiment of the present invention.

FIG. 12 is a plan view of an exposure head portion of an image exposure apparatus according to a fourth embodiment of the present invention.

FIG. 13 is a side view of a drum capstan system of image exposure apparatus according to a fifth embodiment of the present invention.

FIG. 14 is a schematic view of an image exposure apparatus of a so-called outer drum optical fiber array exposure system.

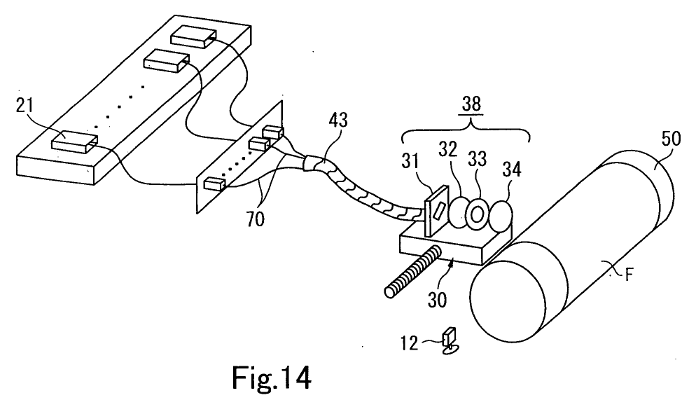

FIG. 15 is a view useful for understanding a variation of light quantity in exposure in the conventional image exposure apparatus.

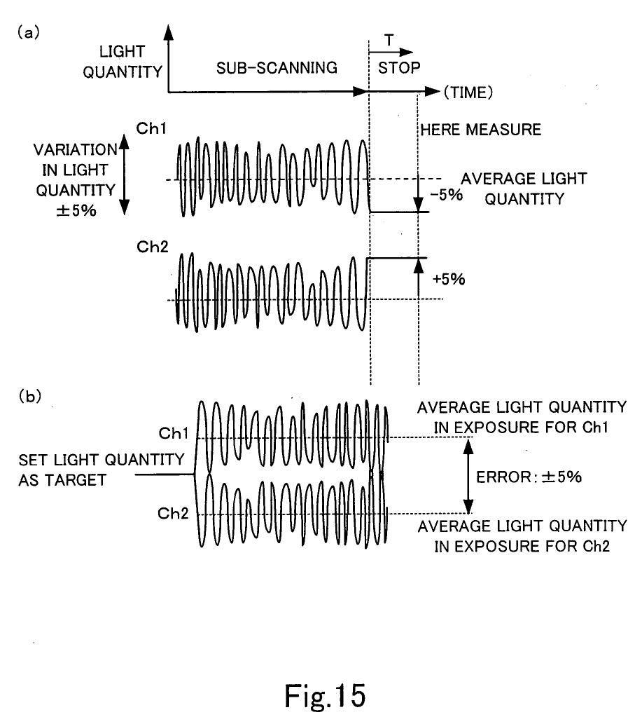

### DETAILED DESCRIPTION OF PREFERRED EMBODIMENTS

Embodiments of the present invention will be described with reference to the accompanying drawings.

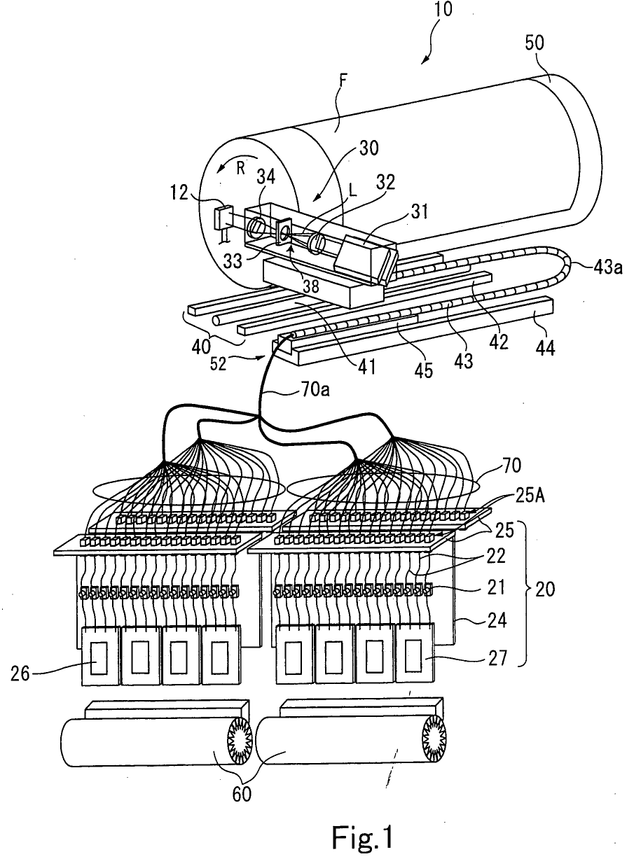

FIG. 1 is a perspective view of an image exposure apparatus according to a first embodiment of the present invention.

An image exposure apparatus 10 comprises a light source unit 20 for generating laser beams, an exposure head 30 for condensing the laser beams generated from the light source unit 20 and emitting the same, an exposure head moving section 40 for moving the exposure head 30 in a sub-scanning direction, and a rotating drum 50 around which a recording medium F is to be wound for image recording, the rotating drum 50 being rotatively driven in an arrow R direction so that the recording medium F is moved in a main scanning direction.

The light source unit 20 comprises a light source substrate 24, a connector substrate 25, and a driving circuit substrate 27. A cooling blower 60, which is disposed adjacent to the light source unit 20, is disposed in a direction that the wind blows against the light source substrate 24, so that the cooling wind generated by the cooling blower 60 suppresses the temperature rise at the time of driving of semiconductor lasers 21.

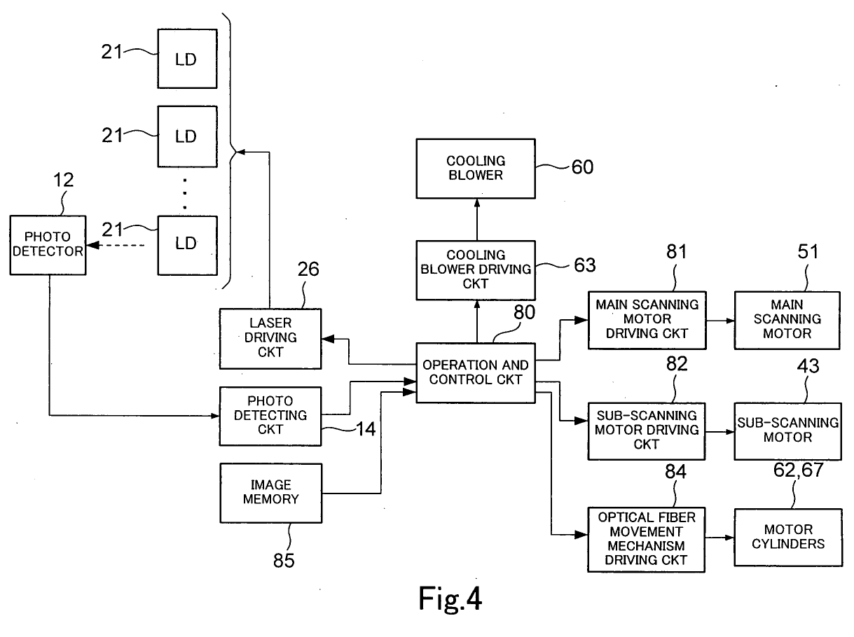

A plurality of semiconductor lasers 21 is disposed on a front side of the light source substrate 24. On a backside of the light source substrate 24, there is provided a heat sink (not illustrated). On the connector substrate 25, there are provided optical connectors 25A the number of which is the same as that of the semiconductor lasers 21. The connector substrate 25 is mounted on a part of the light source substrate 24 on a vertical basis. On the driving circuit substrate 27, there are provided laser driving circuits 26 (cf. FIG. 4) for driving the semiconductor lasers 21 in accordance with image data for an image to be recorded on the recording medium F. The driving circuit substrate 27 is mounted on another part of the light source substrate 24 on a horizontal basis.

A plurality of optical fibers 22 is connected among the laser driving circuits 26, the semiconductor lasers 21 and the optical connectors 25A. Driving signals generated from the laser driving circuits 26 are fed through the optical fibers 22 to the semiconductor lasers 21 so as to be individually driven.

An exposure head 30 comprises an optical system 38 consisting of a fiber array 31, a collimator lens 32, an aperture 33, and an imaging lens 34, which are arranged in the named order. In the fiber array 31, pluralities of optical fibers 70 derived from the optical connectors 25A are connected in series. The fiber array 31 emits laser beams emitted from the plurality of semiconductor lasers 21 every channel. The aperture 33 is disposed in such a manner that the opening section of the aperture 33 is located at the position of the far-field looking toward the aperture 33 at the laser beam emission outlet of the fiber array 31.

The exposure head moving section 40, which moves the exposure head 30 in a sub-scanning direction parallel to the rotary shaft of the rotating drum 50, is provided with a ball screw 41 and two rails 42, which are disposed along the sub-scanning direction. Thus, when a sub-scanning motor 43 (cf. FIG. 4) for rotary-driving the ball screw 41 is operated, the exposure head 30 engaged with the ball screw 41 on a spiral basis can be moved in the sub-scanning direction in a state that the exposure head 30 is guided by the rails 42. The rotating drum 50, around which a recording medium F is wound, rotates in an arrow R in FIG. 1, when a main scanning motor 51 (cf. FIG. 4) is operated, so that the exposure head 30 performs the main scanning.

At the position out of the image recording area by the exposure head 30, that is, at the position out of the recording medium F, there is disposed a monitoring photo detector 12 for detecting light quantity of laser light emitted from the exposure head 30. There is provided such a control that prior to the actual exposure by the exposure head 30, laser lights, which are emitted from the semiconductor lasers 21 and reach the photo detector 12 via the channels of the fiber array 31, are measured so that an operation and control circuit (cf. FIG. 4), which will be described later, control in accordance with the measured values that the light quantity of each of the semiconductor lasers 21 becomes a predetermined value.

The optical fibers 70 derived from the optical connectors 25A are bundled to form a bundled portion 70a. The bundled portion 70a is accommodated in a cable bear 43 (registered trademark) which is flexible holding member. The cable bear 43 is fixed on an optical fiber holding member 45 that is guided by a guide rail 44.

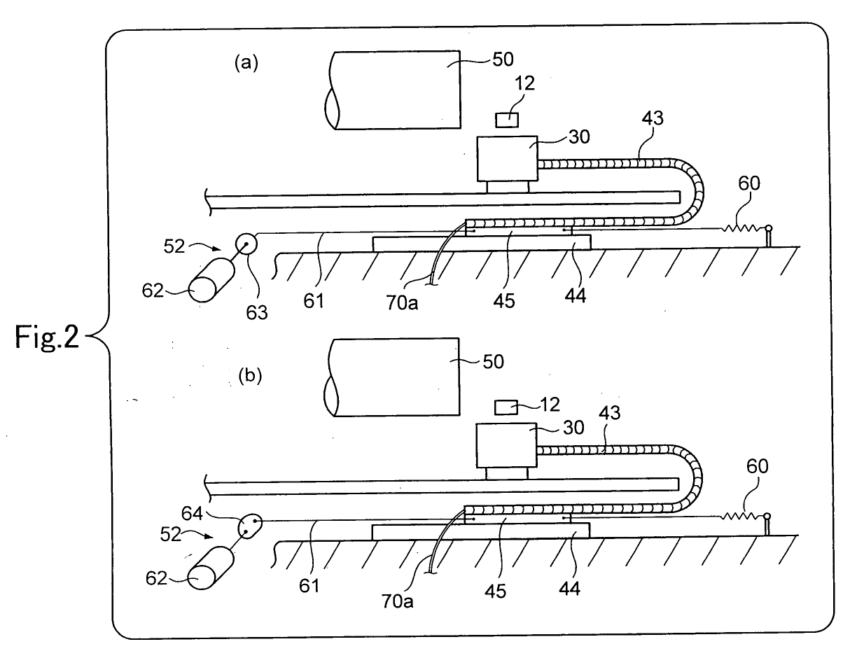

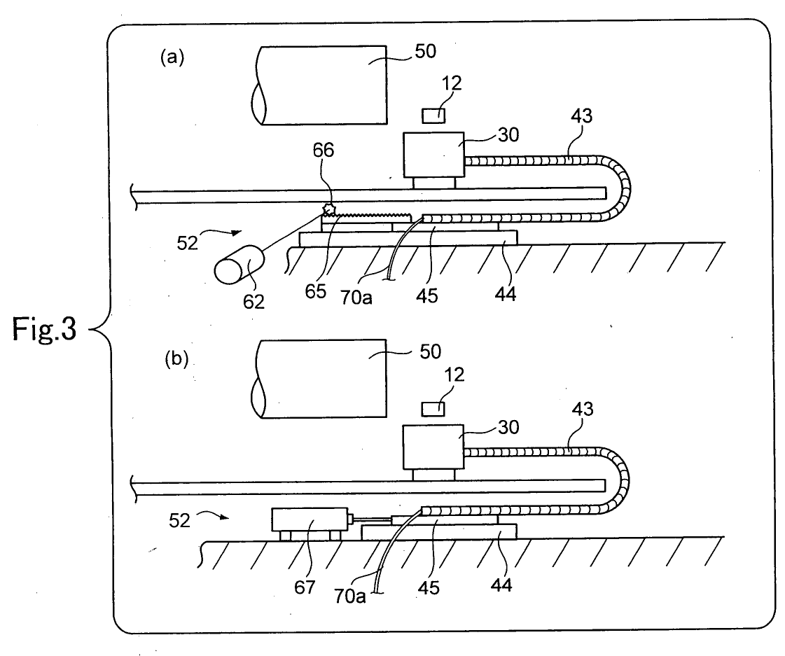

According to the image exposure apparatus according to the first embodiment of the present invention, an optical fiber moving mechanism 52 moves the optical fibers 70 via the cable bear 43, so that the optical fibers 70 are varied and monitoring is performed. FIG. 2 and FIG. 3 show embodiments of the optical fiber moving mechanism 52.

FIG. 2 is a side elevation of an optical fiber moving mechanism (1) of the first embodiment of the present invention.

Part (a) of FIG. 2 shows a structure that the optical fiber holding member 45 is connected to a spring 60 and a stretching wire 61 and the stretching wire 61 is wound around a roller 63 driven by a motor 62 so that the optical fiber holding member 45 moves in the left against the spring 60.

Part (b) of FIG. 2 shows a structure, which is the same as the part (a) of FIG. 2 excepting that the roller 63 is replaced by an eccentric roller 64.

FIG. 3 is a side elevation of an optical fiber moving mechanism (2) of the first embodiment of the present invention.

Part (a) of FIG. 3 shows a structure that a rack 65 is mounted on the optical fiber holding member 45 and the rack 65 is moved by a pinion 66 driven by the motor 62.

Part (b) of FIG. 3 shows a structure that the optical fiber holding member 45 is moved by an air cylinder 67.

Incidentally, the above-mentioned optical fiber moving mechanism 52 are exemplarily shown, and it is noted that any one is acceptable, as the optical fiber moving mechanism 52, which moves the optical fiber holding member 45.

FIG. 4 is a circuit diagram of a control system of an image exposure apparatus 10 of the present invention. As shown in FIG. 4, the control system comprises: a laser driving circuit 26 for driving semiconductor lasers 21 in accordance with image data; a main scanning motor driving circuit 81 for driving a main scanning motor 51; a sub-scanning motor driving circuit 82 for driving a sub-scanning motor 43; an operation and control circuit 80 for controlling a cooling blower driving circuit 63 and a laser driving circuit 26; an optical fiber moving mechanism use driving circuit 84 for driving an optical fiber moving mechanism use motor 62 or an air cylinder 67; a photo detector circuit 14 for detecting a quantity of light detected by the monitoring photo detector 12; and an image memory 85 for storing image data for an image to be recorded on the recording medium F.

Connected to the operation and control circuit 80 are the laser driving circuit 26, the cooling blower driving circuit 63, the main scanning motor driving circuit 81, the sub-scanning motor driving circuit 82, the optical fiber moving mechanism use driving circuit 84, the image memory 85, and the photo detector circuit 14. The operation and control circuit 80 controls those circuits and elements.

The operation and control circuit 80 controls the laser driving circuit 26 in accordance with image data supplied from the image memory 85 so as to control the driving of the semiconductor lasers 21. At the time of the exposure by the exposure head 30, the operation and control circuit 80 controls the cooling blower driving circuit 63, the main scanning motor driving circuit 81, the sub-scanning motor driving circuit 82, so that an image recording is performed while cooling light source substrate 24.

As shown in FIG. 1, prior to the exposure for the recording medium F, first, the exposure head 30 is moved to the front of the photo detector 12. And in this state, the optical fiber holding member 45 is moved by the optical fiber moving mechanism use motor 62 or the air cylinder 67. Thus, the optical fibers 70 are moved via the cable bear 43 and a bending portion 43a of the cable bear 43 is also moved, so that the optical fibers 70 takes behavior similar to a case where a sub-scanning is carried out actually by the exposure head 30.

At the time of a movement of the optical fibers 70, the laser driving circuit 26 injects into the semiconductor lasers 21 of the channels such pulse driving currents that the semiconductor lasers 21 emit lights sequentially.

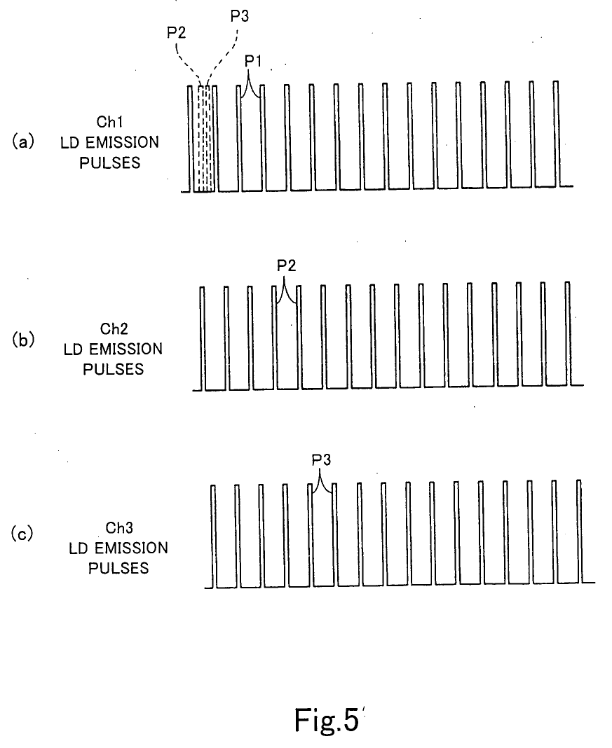

FIG. 5 is a view of timings of light emission pulses of channels at the time of monitor. As shown in FIG. 5, for example, in a case where the semiconductor lasers 21 are concerned with three channels Ch1, Ch2 and Ch3, light emission pulses P1, P2 and P3 are injected into the semiconductor lasers 21 of the channels Ch1, Ch2 and Ch3, respectively, so as not to overlap each other in timing, as shown with dotted lines.

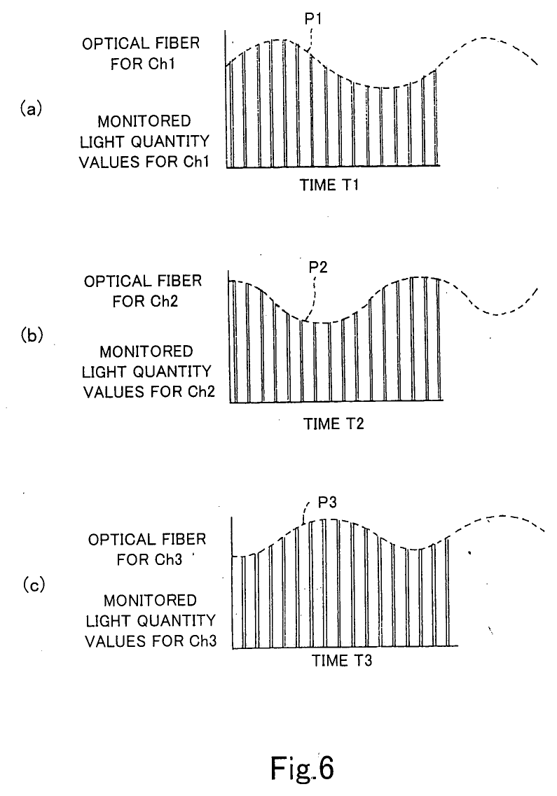

FIG. 6 is a view of monitored light quantity values of channels at the time of monitor. As shown in FIG. 6, the optical fibers 70 of channels Ch1, Ch2 and Ch3 emit monitored light quantity values at times T1, T2 and T3, respectively.

By way of example, in case of the monitor for three channels, if it is assumed that a time required for the sub-scanning 30 mm is 6 m sec and it is measured by 1000 times for a channel, a pulse of 6 m sec/3=2 m sec is repeated with a period of 6 m sec.

At that time, the phase of the channels is shifted by 2 m sec.

In this case, while the number of the light quantity to be monitored is 1000×3=3000, as shown in FIG. 6, it is possible to derive the monitored light quantity values of light emission pulses of channels associated with times T1, T2 and T3, respectively. More in details, the monitored light quantity values are derived from the optical fibers 70 of channels Ch1, Ch2 and Ch3, with respect to the light emission pulses P1, P2 and P3, in the times T1, T2 and T3, respectively.

Where
6n≦T1<6n+2
6n+2≦T2<6n+4
6n+4≦T3<6n+6

(It is assumed that n is an integer of 0 to 999 and continuously varies)

Then the average of the monitored light quantity values is determined for each channel, and the determined average is established as the average light quantity in movement of the cable bear 43 at the time of monitor.

The above-mentioned embodiment discloses an example of the simultaneous monitoring of three channels. However, the light emission of the semiconductor lasers 21 not overlapping each other in time sequence makes it possible to monitor the arbitrary number of channels in a similar fashion.

The photo detector 12 receives the above-mentioned light emission pulses, and the photo detector circuit 14 receives the detection signal so as to be converted into the light quantity of light entered to the photo detector 12. Signals indicative of the light quantity are fed to the operation and control circuit 80 to compute a driving current value so that a target average light quantity at the time of the exposure is obtained, and the operation and control circuit 80 controls the laser driving circuit 26.

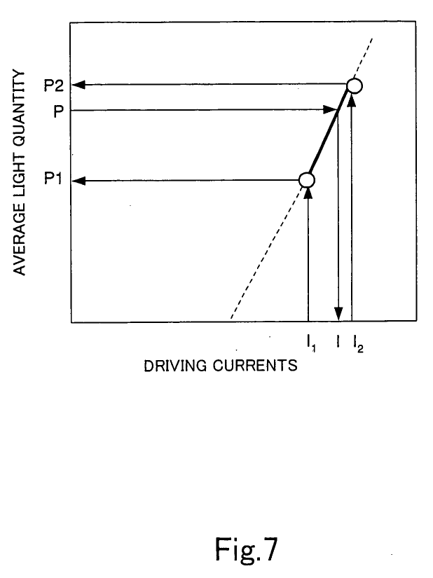

FIG. 7 is an explanatory view useful for understanding a light quantity control by an interpolation. The vertical axis indicates the average light quantity and the horizontal axis indicates the driving current.

First, while the optical fibers 70 move in a one direction (a forward way of reciprocation) via the optical fiber holding member 45 of the optical fiber moving mechanism 52, a predetermined value of pulse driving current I1 is injected from the laser driving circuit 26 into the semiconductor lasers 21. The photo detector 12 receives the pulse lights emitted from the semiconductor lasers 21. The photo detector circuit 14 converts the pulse lights into the light quantity. The operation and control circuit 80 computes a light quantity average value P1 in a predetermined optical fiber moving time (first time).

Next, while the optical fibers 70 are moved from the first time of terminal position in the reverse direction (returning way), the laser driving circuit 26 injects into the semiconductor lasers 21 a pulse driving current I2 of which a value is somewhat higher than that of the first time. The photo detector 12 receives the pulse lights emitted from the semiconductor lasers 21. The photo detector circuit 14 converts the pulse lights into the light quantity. The operation and control circuit 80 computes a light quantity average value P2 in a predetermined optical fiber moving time (second time).

Next, a driving current for obtaining a target light quantity P in the sub-scanning is determined in accordance with the formula (1) set forth below.
I=I1+(P−P1)(I2−I1)/(P2−P1) (1)

Thus, it is possible to stabilize the light quantity of the laser beams emitted from the semiconductor lasers 21 to the target light quantity P.

According to the above-mentioned interpolation, the driving currents I1 and I2, which are different from one another between the forward way of reciprocation and the returning way, are injected to the semiconductor lasers 21. This feature needs no operation for returning the optical fiber moving mechanism 52 to the home position. Thus, it is possible to reduce the measured time. It is acceptable that the same operation is carried out varying the driving currents I1 and I2 only in the forward way of reciprocation or the returning way.

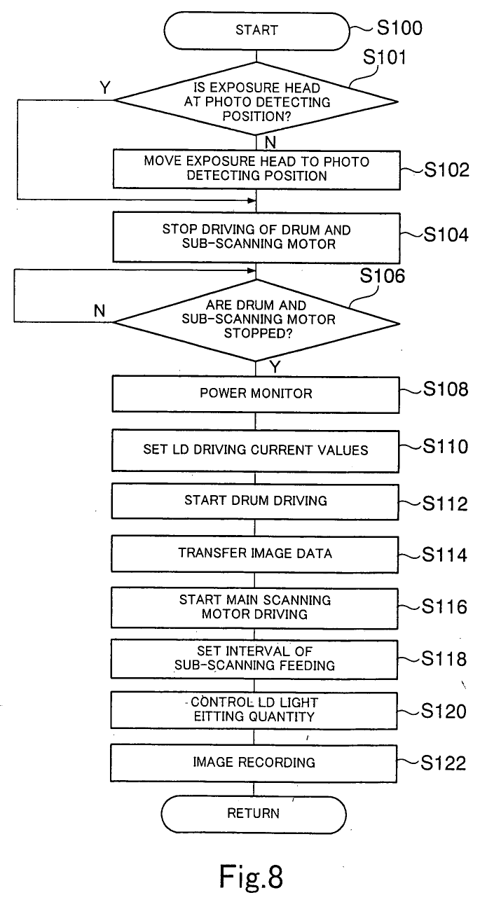

FIG. 8 is a flowchart useful for understanding processing when the image recording is performed.

First, the exposure head 30 starts (step S100). In step S101, it is decided whether the exposure head 30 is in a photo detection position. With respect to the determination of the photo detection position, for example, it is acceptable that a sensor is used to detect the position of the exposure head 30. Alternatively it is acceptable that the exposure head 30 emits light and it is decided as to whether the photo detector 12 detects the light emitted from the exposure head 30.

When it is decided in the step S101 that the exposure head 30 is not in the photo detection position, the operation and control circuit 80 controls the sub-scanning motor driving circuit 82 so that light is incident on the photo detector 12, and the sub-scanning motor 43 is driven so that the exposure head 30 moves to a position against the photo detector 12 (step S102). When it is decided in the step S101 that the exposure head 30 is in the photo detection position, the operation and control circuit 80 stops driving of the main scanning motor 51 (the rotating drum 50) and the sub-scanning motor 43 (step S104).

In step S106, it is decided as to whether the rotating drum 50 and the sub-scanning motor 43 are stopped. When it is decided that the rotating drum 50 and the sub-scanning motor 43 are stopped, the process goes to a step S108.

In the step S108, there is performed a power monitor in which while the optical fiber moving mechanism use driving circuit 84 is controlled to move the optical fibers 70 via the optical fiber holding member 45 and the cable bear 43, the pulse driving currents as shown in FIG. 5 are injected to the semiconductor lasers 21 so as to detect light to be entered from the exposure head 30 to the photo detector 12. In step S110, the photo detector circuit 14 converts the signals from the photo detector 12 into light quantity, and the operation and control circuit 80 performs the operation in accordance with the above-mentioned formula (1), so that driving current values I for the semiconductor lasers 21 are set up. When the laser driving circuit 26 is controlled by the driving current values I, the light quantity of the laser beam obtained from the semiconductor lasers 21 through the optical fibers 70 becomes a set light quantity as a target.

In step S112, the operation and control circuit 80 controls the main scanning motor driving circuit 81 to start the rotation of the rotating drum 50, so that the rotation of the rotating drum 50 is initiated.

In step S114, when image data is transmitted from the image memory 85 for storing image data for an image to be recorded on the recording medium F to the operation and control circuit 80, the operation and control circuit 80 supplies the transmitted image data and signals regulated in accordance with resolution data indicative of a predetermined resolution of a recording image to the laser driving circuit 26, the main scanning motor driving circuit 81, and the sub-scanning motor driving circuit 82.

In step S116, the main scanning motor driving circuit 81 controls the main scanning motor 51 to rotate the rotating drum 50 in an arrow R direction at the rotating speed according to the resolution data in accordance with the signal fed from the operation and control circuit 80. In step S118, the sub-scanning motor driving circuit 82 sets up a feeding speed in the sub-scanning direction for the exposure head 30 by the sub-scanning motor 43 in accordance with the resolution data.

Next, the laser driving circuit 26 drives the semiconductor lasers 21 in accordance with image data. At that time, the driving current is the driving current value I that is obtained through the operation at that time of monitoring (step S120). The laser light beams emitted from the semiconductor lasers 21 are emitted from the fiber array 31 via the optical fibers 22, the optical connectors 25A and the optical fibers 70, and are emitted on the recording medium F on the rotating drum 50 via the image-forming lens 34 in form of the parallel beam of light by the collimator lens 32.

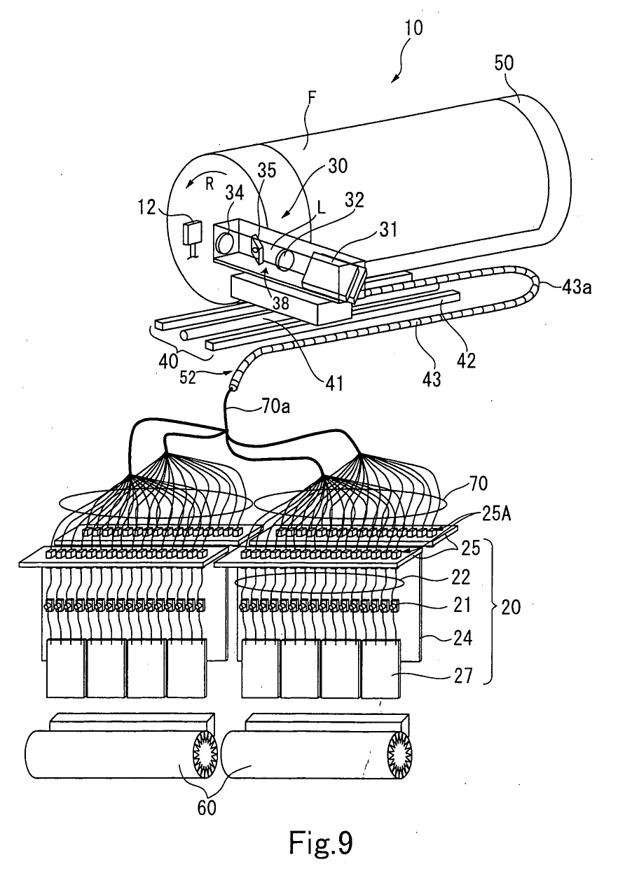

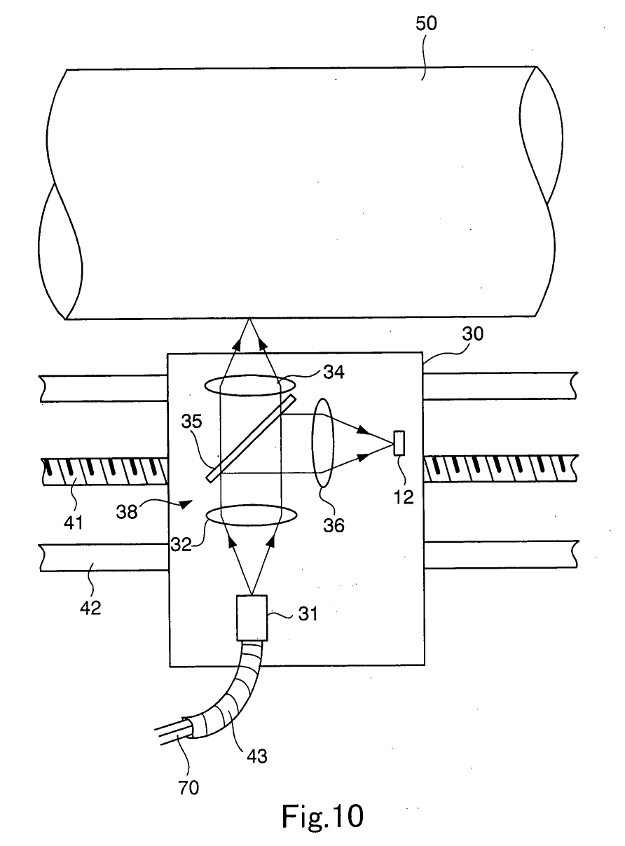

FIG. 9 is a perspective view of an image exposure apparatus according to a second embodiment of the present invention. FIG. 10 is a plan view of an exposure head portion of the second embodiment. According to the second embodiment, the monitoring is carried out while the exposure head 30 is moved to perform the sub-scanning.

As shown in FIG. 10, the exposure head 30 comprises: an optical system 38 consisting of a fiber array 31, a collimator lens 32, and an imaging lens 34; a half mirror 35 provided between the collimator lens 32 and the imaging lens 34; a photo detector 12 for receiving reflected light from the half mirror 35 via a condensing lens 36. The light emitted from the fiber array 31 partially reaches the rotating drum 50 passing through the half mirror 35, and the remaining light is reflected by the half mirror 35 and reaches the photo detector 12.

The optical fibers 70 are bundled and accommodated in a cable bear 43 that is a flexible accommodating member. The optical fibers 70 moves bending in the wake of the exposure head 30 at the time of the sub-scanning. A waveguide mode (a light intensity distribution in the optical fiber) varies in accordance with a bending state of the optical fibers 70, so that a far-field pattern of the emitted light from the fiber array 31 varies. The emitted light is received by the recording medium F wound around the rotating drum 50 and the photo detector 12.

Prior to the exposure, the exposure head 30 is moved in a similar fashion to that of the sub-scanning. As a result, the optical fibers 70 moves via the cable bear 43 and the bending portion 43a (cf. FIG. 1) of the cable bear 43 is also moved, so that the optical fibers 70 takes behavior similar to a case where a sub-scanning is carried out actually by the exposure head 30. At the time of a movement of the optical fibers 70, the pulse driving currents are injected from the laser driving circuit 26 to the semiconductor lasers 21 for the channels to emit the lights.

With respect to the point that the photo detector 12 receives the emitted lights from the optical fibers 70, and the average light quantity of lights from the semiconductor lasers 21 for the channels in a movement of the optical fibers 70 is determined in accordance with the signal from the photo detector 12, so as to operate the driving currents to be supplied to the semiconductor lasers 21 at the time of the exposure from the determined average light quantity, this is the same as the first embodiment, and thus the explanation will be omitted.

The light quantity control according to the interpolation shown in FIG. 5 is also applicable to the second embodiment. That is, first, while the exposure head 30 is moved in a one direction (forward way of reciprocation), a predetermined value of pulse driving current I1 is injected from the laser driving circuit 26 into the semiconductor lasers 21. The photo detector 12 receives the pulse lights emitted from the semiconductor lasers 21. The photo detector circuit 14 converts the pulse lights into the light quantity. The operation and control circuit 80 computes a light quantity average value P1 in a predetermined optical fiber moving time (first time).

Next, while the exposure head 30 is moved from the first time of terminal position in the reverse direction (returning way), the laser driving circuit 26 injects into the semiconductor lasers 21 a pulse driving current I2 of which a value is somewhat higher than that of the first time. The photo detector 12 receives the pulse lights emitted from the semiconductor lasers 21. The photo detector circuit 14 converts the pulse lights into the light quantity. The operation and control circuit 80 computes a light quantity average value P2 in a predetermined optical fiber moving time (second time). Next, a driving current for obtaining a target light quantity P in the sub-scanning is determined in accordance with the above-referenced formula (1).

According to the second embodiment, the photo detector 12 is mounted on the exposure head 30. This feature may avoid the necessity for positioning of the exposure head 30 as in the first embodiment, when the monitoring is performed, and makes it possible to perform the monitor operation even during the sub-scanning in the exposure.

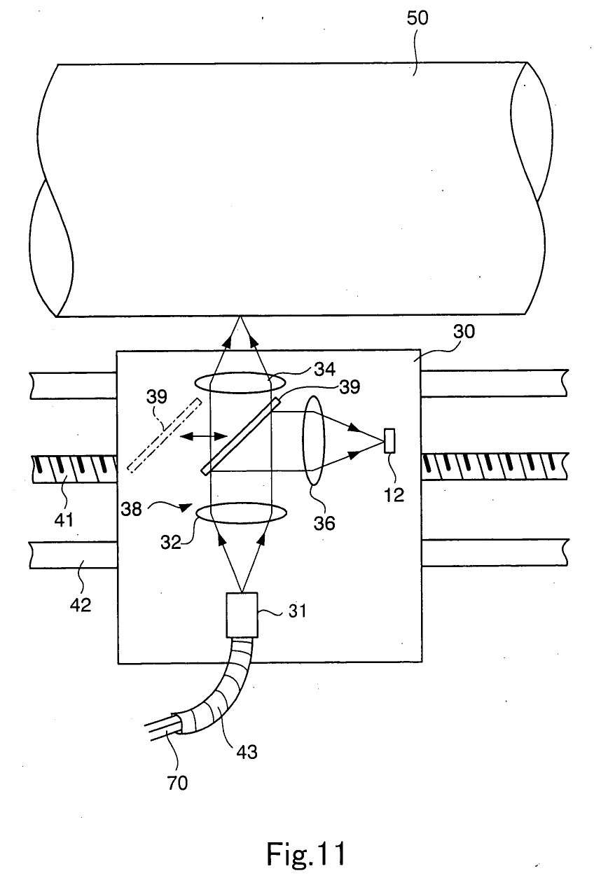

FIG. 11 is a plan view of an exposure head portion of an image exposure apparatus according to a third embodiment of the present invention. Also in accordance with the third embodiment, the monitoring is performed while the exposure head 30 is moved.

As shown in FIG. 11, the exposure head 30 comprises: the optical system 38 consisting of the fiber array 31, the collimator lens 32, and the imaging lens 34; a total reflection mirror 39 movably provided between the collimator lens 32 and the imaging lens 34; and the photo detector 12 for receiving reflected light from the total reflection mirror 39 via a condensing lens 36.

When the total reflection mirror 39 is located at the position as indicated with the solid line, the light emitted from the fiber array 31 is reflected by the total reflection mirror 39 and reaches the photo detector 12. When the total reflection mirror 39 shifts to the position as indicated with the dot dash line out of the optical path, all the lights emitted from the fiber array 31 reach the rotating drum 50.

Prior to the sub-scanning operation, the total reflection mirror 39 is located at the position as indicated with the solid line, and the exposure head 30 is moved in the same manner as the actual sub-scanning operation. Thus, the optical fibers 70 also move via the cable bear 43 and the bending portion 43a (cf. FIG. 1) of the cable bear 43 is also moved, so that the optical fibers 70 takes behavior similar to a case where a sub-scanning is carried out actually by the exposure head 30. At the time of a movement of the exposure head 30, the laser driving circuit 26 injects into the semiconductor lasers 21 of the channels such pulse driving currents that the semiconductor lasers 21 emit lights. Hereinafter the operation is the same as that of the second embodiment.

A movement of the total reflection mirror 39 to the position as indicated with the dot dash line at the time of the actual exposure makes all the emitted lights from the fiber array 31 reach the rotating drum 50.

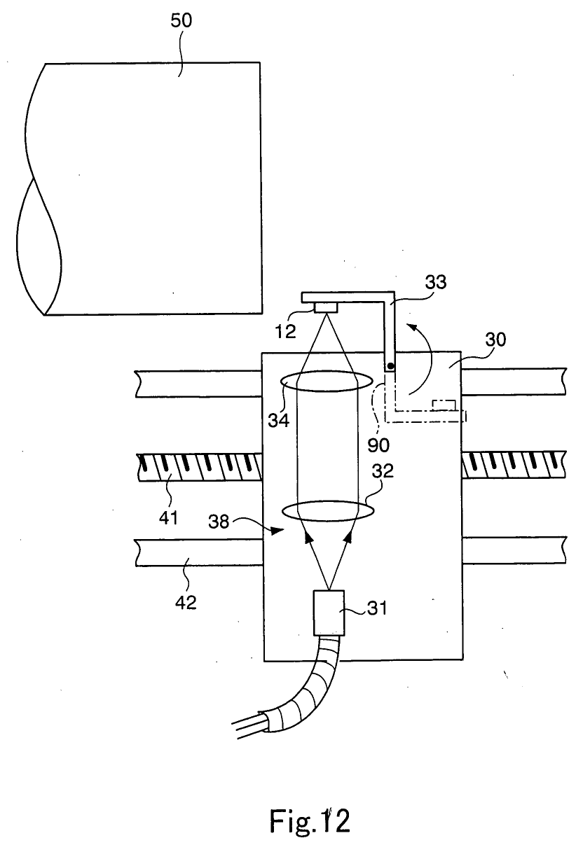

FIG. 12 is a plan view of an exposure head portion of an image exposure apparatus according to a fourth embodiment of the present invention. Also in accordance with the fourth embodiment, the monitoring is performed while the exposure head 30 is moved.

As shown in FIG. 12, the exposure head 30 comprises the optical system 38 consisting of the fiber array 31, the collimator lens 32, and the imaging lens 34; and the photo detector 12 mounted on a movable lever 33. The movable lever 33 is rotatably supported by a shaft 90 and is rotatable on the shaft 90.

When the movable lever 33 is located at the position as indicated with the solid line, the light emitted from the fiber array 31 reaches the photo detector 12. When the movable lever 33 shifts to the position as indicated with the dot dash line, all the lights emitted from the fiber array 31 reach the rotating drum 50.

Prior to the sub-scanning operation, the movable lever 33 is located at the position as indicated with the solid line, and the exposure head 30 is moved in the same manner as the actual sub-scanning operation. Thus, the optical fibers 70 also move via the cable bear 43 and the bending portion 43a (cf. FIG. 1) of the cable bear 43 is also moved, so that the optical fibers 70 takes behavior similar to a case where a sub-scanning is carried out actually by the exposure head 30. At the time of a movement of the exposure head 30, the laser driving circuit 26 injects into the semiconductor lasers 21 of the channels such pulse driving currents that the semiconductor lasers 21 emit lights. Hereinafter the operation is the same as that of the second embodiment. A movement of the movable lever 33 to the position as indicated with the dot dash line at the time of the actual exposure makes all the emitted lights from fiber array 31 reach the rotating drum 50.

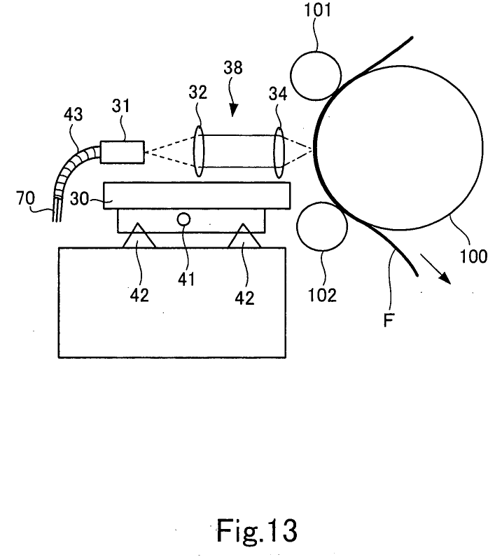

FIG. 13 is a side view of a drum capstan system of image exposure apparatus according to a fifth embodiment of the present invention.

The image exposure apparatus has a drum 100, and a pair of capstans 101 and 102, which cause the recording medium F to move in the arrow direction when the drum 100 rotates urging the recording medium F to the drum 100. The exposure head 30 includes the optical system 38 consisting of a fiber array 31, a collimator lens 32, and an imaging lens 34, which are arranged in the named order. The fiber array 31 is connected to the optical fibers 70. The exposure head 30 is mounted on a ball screw 41 and two rails 42. When the ball screw 41 is driven, the exposure head 30 is moved in a state that the rails 42 guide the exposure head 30. The exposure head 30 performs the sub-scanning operation through a movement of the recording medium F by the capstans 101 and 102 in the arrow direction, and performs the main scanning operation through a movement in a direction (the direction of rails 42) perpendicular to a movement direction of the recording medium F. The monitoring method according to the first to fourth embodiments is also applicable to the drum capstan system of image exposure apparatus.

According to the various embodiments, pulses drive pluralities of semiconductor lasers on a time sequential basis. However, it is acceptable that whenever the optical fiber is reciprocated once, pluralities of semiconductor lasers are continuously driven one by one sequentially, but not pulse driving, and the optical fiber is reciprocated by the same number of times as the number of the semiconductor lasers. In this case, while it takes a lot of time for determining driving current values to cause the semiconductor lasers to emit lights with a desired light quantity, it is possible to determine the driving current values with greater accuracy.

As mentioned above, according to the present invention, since the photo detection is carried out when the optical fiber performs the bending and behavior which are approximated to a case where the exposure head actually performs exposure, it is possible to accurately compute the target light quantity necessary for the exposure, and also to reduce variation in light quantity at the time of the exposure and thereby performing the exposure with greater accuracy.

Further, according to the present invention, the light detection is carried out in such a manner that pluralities of semiconductor lasers emit lights with pulses on a time sequence basis. This feature makes it possible to detect at once lights of a plurality of channels and thereby improving productivity.

Although the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

1. An image exposure method in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure method comprising:
a first step of deforming the optical fiber while the semiconductor laser is driven;
a second step of detecting light quantity of emitted light from the exposure head during an operation of deformation of the optical fiber;
a third step of operating average light quantity in accordance with the light quantity detected in the second step;
a fourth step of operating a value of current to drive the semiconductor laser in accordance with a difference between the average light quantity and a target light quantity necessary for exposure; and
a fifth step of driving the semiconductor laser with the current of the value operated in the fourth step to expose the recording medium.

2. An image exposure method according to claim 1, wherein the first step is a step in which while the optical fiber is deformed, pluralities of semiconductor lasers are driven with pulses on a time sequence basis.

3. An image exposure apparatus in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure apparatus comprising:
an optical fiber holding member that movably holds a part of the optical fiber up to the exposure head;
a photo detector that detects light quantity of emitted light from the exposure head during a movement of the optical fiber by the optical fiber holding member;
a control means that drives the semiconductor laser in a state that the exposure head is fixed, while the optical fiber holding member is moved; and
an operating means that operates average light quantity in accordance with the light quantity detected by the photo detector, and operates a value of current to drive the semiconductor laser in accordance with a difference between the average light quantity and a target light quantity necessary for exposure.

4. An image exposure apparatus according to claim 3, wherein the semiconductor laser is of a plurality, and the control means drives the plurality of semiconductor lasers with pulses on a time sequence basis in the state that the exposure head is fixed, while the optical fiber holding member is moved.

5. An image exposure apparatus according to claim 3, wherein the image exposure apparatus further comprises a rotating drum around which the recording medium is wound for image recording, wherein the exposure head moves in parallel to a rotary shaft of the rotating drum to perform a sub-scanning, and the exposure head perform a main scanning by a movement of the recording medium by a rotation of the rotating drum.

6. An image exposure apparatus according to claim 3, wherein the image exposure apparatus further comprises a drum, and a pair of capstans, which cause the recording medium to move in a peripheral direction of the drum when the drum rotates urging the recording medium to the drum, and wherein the exposure head performs a main scanning by a movement of the exposure head in a direction perpendicular to a movement direction of the recording medium, and the exposure head performs a sub-scanning by a movement of the recording medium by the capstans.

7. An image exposure apparatus according to claim 3, wherein the image exposure apparatus further comprises a flexible protecting member provided around the optical fiber.

8. An image exposure apparatus according to claim 3, wherein the photo detector is mounted on a place other than the exposure head.

9. An image exposure apparatus according to claim 3, wherein the photo detector is mounted on the exposure head.

10. An image exposure apparatus according to claim 3, wherein the operating means supplies a driving current of either one of driving currents I1 and I2, which cause the semiconductor laser to emit lights of light quantities P1 and P2 before and after a target light quantity P, to the semiconductor laser in a forward way of reciprocation as a movement of an optical fiber moving means in one direction, and the operating means supplies another driving current of the driving currents I1 and I2 to the semiconductor laser in a returning way of reciprocation as a movement of the optical fiber moving means in another direction, so that the operating means determines a driving current I in accordance with a formula set forth below.
I=I1+(P−P1)(I2−I1)/(P2−P1)

11. An image exposure apparatus in which a light beam emitted from a semiconductor laser is introduced through an optical fiber to an exposure head, and the exposure head forms an image on a sensitive member of a recording medium, so that the sensitive member of the recording medium is exposed by a scanning movement of the exposure head, the image exposure apparatus comprising:
a photo detector that detects light quantity of emitted light from the exposure head during a movement of the exposure head;
a control means that drives the semiconductor laser, while the exposure head is moved; and
an operating means that operates average light quantity in accordance with the light quantity detected by the photo detector, and operates a value of current to drive the semiconductor laser in accordance with a difference between the average light quantity and a target light quantity necessary for exposure.

12. An image exposure apparatus according to claim 11, wherein the semiconductor laser is of a plurality, and the control means drives the plurality of semiconductor lasers with pulses on a time sequence basis, while the exposure head is moved.

13. An image exposure apparatus according to claim 11, wherein the image exposure apparatus further comprises a rotating drum around which the recording medium is wound for image recording, wherein the exposure head moves in parallel to a rotary shaft of the rotating drum to perform a sub-scanning, and the exposure head perform a main scanning by a movement of the recording medium by a rotation of the rotating drum.

14. An image exposure apparatus according to claim 3, wherein the image exposure apparatus further comprises a drum, and a pair of capstans, which cause the recording medium to move in a peripheral direction of the drum when the drum rotates urging the recording medium to the drum, and
wherein the exposure head performs a main scanning by a movement of the exposure head in a direction perpendicular to a movement direction of the recording medium, and the exposure head performs a sub-scanning by a movement of the recording medium by the capstans.

15. An image exposure apparatus according to claim 11, wherein the image exposure apparatus further comprises a flexible protecting member provided around the optical fiber.

16. An image exposure apparatus according to claim 11, wherein the exposure head has a half mirror included in an optical system of the exposure head, the half mirror directing light emitted from the optical fiber to a direction of the recording medium and reflecting the light emitted from the optical fiber to a direction of the photo detector.

17. An image exposure apparatus according to claim 11, wherein the exposure head has a total reflection mirror removably included in an optical system of the exposure head, the total reflection mirror reflecting light emitted from the optical fiber to a direction of the photo detector.

18. An image exposure apparatus according to claim 11, wherein the photo detector is mounted on the exposure head via a photo detector moving mechanism that moves to a position to receive emitted light of the exposure head and moves to a position saving from the position to receive emitted light of the exposure head.

19. An image exposure apparatus according to claim 11, wherein the operating means supplies a driving current of either one of driving currents I1 and I2, which cause the semiconductor laser to emit lights of light quantities P1 and P2 before and after a target light quantity P, to the semiconductor laser in a forward way of reciprocation as a movement of an optical fiber moving means in one direction, and the operating means supplies another driving current of the driving currents I1 and I2 to the semiconductor laser in a returning way of reciprocation as a movement of the optical fiber moving means in another direction, so that the operating means determines a driving current I in accordance with a formula set forth below.
I=I1+(P−P1)(I2−I1)/(P2−P1)
